(19) United States
(12) Patent Application Publication
(10) Pub. No.: US 2026/0338311 A1
(43) Pub. Date: Oct. 29, 2026

(54) REPAIR SYSTEM AND METHOD FOR REPAIRING LOCALIZED DEFECTS IN A PIPE FOR FLUID TRANSPORT

(71) Applicant: SAIPEM S.P.A., Milano (IT)

(72) Inventors: Loris Ziero, Milano (IT); Diego Lazzarin, Milano (IT); Diego Bruno, Milano (IT)

(21) Appl. No.: 19/107,365

(22) PCT Filed: Sep. 5, 2023
(86) PCT No.: PCT/IB2023/058772

§ 371 Date: Feb. 27, 2025

(30) Foreign Application Priority Data
Sep. 6, 2022 (IT) 102022000018195

(51) Int. Cl. F16L 55/17; F16L 1/26; F16L 55/18

(52) U.S. Cl. CPC F16L 55/171; F16L 1/26; F16L 55/18

(57) ABSTRACT

A repair system for repairing localized defects of a pipe extends along a first longitudinal axis (A2) and has a seal plate (12), which is configured to be arranged in contact with the outer surface of the pipe (2) above the defect (4) to be repaired; a compression frame (16), which is configured to be fixed to the pipe (2) and is arranged around the seal plate (12) so as to delimit together with the seal plate (12) a gap (17), which has a variable size along the first longitudinal axis (Al); and at least one sliding element (18), which is configured to slide within said gap (17) along the first longitudinal axis (A2) and to wedge between the compression frame (16) and the seal plate (12) so as to push the seal plate (12) against the outer surface of the pipe (2).

### CROSS-REFERENCE TO RELATED APPLICATIONS

This Patent Application claims priority from Italian Patent Application No. 102022000018195 filed on Sep. 6, 2022, the entire disclosure of which is incorporated herein by reference.

### TECHNICAL FIELD

The present invention relates to a repair system and method for repairing localized defects in a pipe for fluid transport.

In addition, the present invention relates to an underwater intervention assembly comprising said repair system.

### STATE OF THE ART

As is known, it is necessary in the oil and gas industry to transport fluids, such as hydrocarbons or process liquids, over long distances via pipes. Typically, said pipes extend in a body of water, in particular over a bed of the body of water or in intermediate positions, and are made of metal materials.

It sometimes occurs that corrosion phenomena can lead to a degradation of the pipe and to a loss of tightness of the pipe. In particular, the metal materials used for the manufacture of pipes typically have great affinity with numerous chemical elements, including oxygen, sulphur, water, hydrogen and carbon dioxide. At least one of the aforementioned chemical elements is often contained in the fluid transported by the pipe and/or is present in the environment outside the pipe. In practice, corrosion of the pipe results in a technological deterioration of the metal material it is made of and leads to both a macroscopic dissolution of the metal material, sometimes causing the perforation of the pipe, and a loss in thickness of the pipe.

More specifically, corrosion can be generalized and affect the entire surface of the metal material, resulting in a reduction in the thickness of the metal walls of the pipe, or it can be localized and affect limited parts of the metal surface of the pipe, resulting in the formation of defects or cavities in the metal surface that can run through the walls of the metal surface. A further type of corrosion is selective corrosion, which results in the dissolution of specific portions of the metal material of the pipe which, for chemical or metallographic reasons, are more vulnerable to attack.

In cases where the pipe is subject to localized corrosion, it is known to repair the defects resulting from this type of corrosion by means of lightweight, easy-to-handle repair devices which employ external clamps that can be installed by divers. These devices are commonly referred to as “lightweight clamps” or “lightweight clamping devices”.

For instance, documents U.S. Pat. Nos. 6,334,465 and 8,978,709 describe respective repair devices for stopping a leak from a crack in a pipe. Each repair device comprises a sealing assembly provided with a deformable elastomeric sheet to be applied to the crack, and a clamping mechanism equipped with two clip portions connected to each other by tie rods and arranged around the sealing assembly and the pipe to be repaired. In practice, thanks to the tie rods, it is possible to tighten the two clip portions around the pipe, whereby shear forces are applied to the sealing assembly so as to bring about the adherence and deformation of the elastomeric sheet over the crack to be repaired.

However, in known repair devices, the considerable flexibility of the elastomeric sheet results in an uncontrolled deformation of the elastomeric material when the elastomeric sheet is subjected to high pressures and/or high temperatures. This drawback limits the range of use of known repair devices at low pressures and temperatures.

Furthermore, since the elastomeric sheet is easily deformed, the compression force that can be exerted on the sealing assembly by the clamping mechanisms described in U.S. Pat. Nos. 6,334,465 and 8,978,709 is limited and is not adapted to compress sheets of stiffer material on the outer surface of the pipe to be repaired.

In cases where the repair device requires greater compression forces, clamping mechanisms configured to exert high compression forces on the pipe are known. However, said mechanisms are heavy and bulky and, as a result, limit the ease and speed of installation of the repair device in which they are incorporated.

Moreover, currently known repair devices are only designed to be installed by divers.

### SUMMARY OF THE INVENTION

An object of the present invention is to provide a repair system for repairing localized defects of a pipe for fluid transport that is capable of overcoming the drawbacks of the known art. In particular, an object of the present invention is to provide a repair system which is capable of exerting high compression forces on stiff sealing elements, which can be used at high pressures and temperatures, and which is easy and quick to install, in particular by means of an unmanned underwater vehicle.

In accordance with the present invention, a repair system is provided for repairing localized defects of a pipe for fluid transport, the repair system extending along a first longitudinal axis and comprising:
a seal plate, which is configured to be arranged in contact with the outer surface of the pipe above the defect to be repaired;
a compression frame, which is configured to be fixed to the pipe and is arranged around the seal plate so as to delimit together with the seal plate a gap, which extends along the first longitudinal axis and has a variable size along the first longitudinal axis; and
at least one sliding element, which is configured to slide within said gap along the first longitudinal axis and to wedge between the compression frame and the seal plate so as to push the seal plate against the outer surface of the pipe.

Thanks to the present invention, it is possible to use the repair system at high pressures and temperatures and to exert high compression forces on the seal plate in a simple and effective manner without the need to set up a heavy and cumbersome compression mechanism.

Due to its simplicity, the repair system can be installed quickly on the pipe to be repaired by means of an unmanned underwater vehicle. It is thus possible to use the repair system in emergency circumstances.

In particular, the at least one sliding element is wedge-shaped.

It is thereby possible to wedge the sliding element in a pressurized manner into the gap between the compression frame and the seal plate in a simple and effective manner.

More specifically, the repair system comprises a pair of wedge-shaped sliding elements configured to slide oppositely along the first longitudinal axis.

It is thereby possible to distribute the compression thrust exerted by the two sliding elements evenly over the seal plate.

In particular, the seal plate has a profile curved in a direction substantially perpendicular to the first longitudinal axis so as to follow the circumferential profile of the pipe to be repaired.

It is thereby possible to ensure an optimal adherence between the sealing plate and the outer surface of the pipe.

In particular, the seal plate comprises a central section and a lateral end aligned along the first longitudinal axis; the thickness of the seal plate being maximum at said central section and being minimum at said lateral end; preferably said thickness being linearly decreasing along the first longitudinal axis from said central section towards said lateral end.

In practice, the gap has a wedge-shaped longitudinal section corresponding to the wedge-shaped profile of the sliding element.

It is thereby possible to allow the sliding element to slide within the gap between a release position, in which the sliding element exerts a minimal compression force on the seal plate, and a compression position, in which the sliding element is wedged under pressure inside the gap.

A retrograde sliding of the sliding element from the compression position to the release position is prevented by the static friction of the surfaces of the sliding element in contact with the compression frame and with the seal plate. In practice, the contact surfaces of the sliding element find an acute angle relative to each other that is dimensioned to generate a static friction on the seal plate and on the compression frame in order to prevent a retrograde sliding of the sliding element when the sliding element is in the compression position.

In particular, the seal plate is provided with at least one seat for housing a seal gasket around the defect to be repaired.

More specifically, the at least one seat is substantially annular in shape and is formed in a face of the seal plate configured to be arranged in contact with the outer surface of the pipe.

It is thereby possible, in cases where the defect to be repaired comprises an opening that runs through a wall of the pipe, to guarantee the hydraulic tightness of the pipe.

More specifically, the seal plate comprises a first seat and a second seat, which is arranged concentrically around the first seat.

In practice, the first seat is configured to house a first seal gasket to prevent the leakage of fluid from the pipe and the second seat is configured to house a second seal gasket to prevent the entry of an external fluid into the pipe.

In particular, the repair system comprises at least one annular seal gasket, which is housed in the at least one seat and is made of a polymeric material; preferably, the at least one seal gasket having a C-shaped section.

The pressure of the fluid pushing on the C-shaped seal gasket thereby causes the ends of said seal gasket to diverge, resulting in an optimal adherence between the seal gasket and the outer surface of the pipe and between the seal gasket and the seal plate.

In particular, the compression frame comprises a central portion arranged around the seal plate so as to delimit the gap together with the seal plate, and a pair of lateral portions fixed to the central portion so as to enclose the seal plate in a direction substantially parallel to the first longitudinal axis.

It is thereby possible to fix the longitudinal position of the seal plate in relation to the compression frame.

In particular, the seal plate and the compression frame are made at least partially of a metal material.

It is thereby possible to ensure that the repair system possesses an adequate rigidity.

In particular, the repair system comprises an actuating device, which is selectively couplable/decouplable to/from the at least one sliding element and is configured to drive the sliding of the at least one sliding element along the first longitudinal axis.

It is thereby possible to couple the actuating device to the sliding element of a given repair system, to drive the sliding of the sliding element into the gap so as to wedge the sliding element between the compression frame and the seal plate, and subsequently to decouple the actuating device from the sliding element in order to reuse the actuating device in a further repair system.

A further object of the present invention is to provide an underwater intervention assembly for repairing localized defects of an underwater pipe which is capable of overcoming the drawbacks of the known art.

According to the present invention, an underwater intervention assembly for repairing localized defects of an underwater pipe for fluid transport is provided, the intervention assembly comprising:
the repair system as previously described; and
an unmanned underwater vehicle for transporting and installing the repair system on the pipe to be repaired.

It is thereby possible to install the repair system without the need to use divers. Consequently, it is also possible to install the repair system on pipes that are located at great depths in a body of water.

A further object of the present invention is to provide a repair method for repairing localized defects of a pipe for fluid transport which is capable of overcoming the drawbacks of the known art.

According to the present invention, a repair method is provided for repairing localized defects of a pipe for fluid transport, the repair method comprising the steps of:
arranging a seal plate in contact with the outer surface of the pipe above the defect to be repaired;
arranging a compression frame around the seal plate so as to delimit together with the seal plate a gap, which extends along a first longitudinal axis and has a variable size along the first longitudinal axis;
fixing the compression frame to the pipe to be repaired by means of a fastening assembly; and
driving the sliding of at least one sliding element within said gap along the first longitudinal axis to wedge the sliding element between the compression frame and the seal plate so as to push the seal plate against the outer surface of the pipe to be repaired.

Thanks to the present method, it is possible to apply the seal plate in a pressurized manner over a defect of the pipe in a simple and quick manner, which ensures an optimal sealing of the pipe.

### BRIEF DESCRIPTION OF THE DRAWINGS

Further characteristics and advantages of the present invention will become apparent from the following description of a non-limiting example embodiment with reference to the accompanying Figures, wherein:

FIG. 1 is a perspective view, with parts removed for clarity and parts schematized, of an underwater intervention assembly provided in accordance with an embodiment of the present invention;

FIG. 2 is a perspective view, with parts removed for clarity and parts schematized, of the underwater intervention assembly of FIG. 1 provided in accordance with a further embodiment of the present invention;

FIGS. 3 and 4 are section views, with parts removed for clarity, of a repair system of the underwater intervention assembly of FIG. 1 in respective operating configurations and installed on a pipe to be repaired;

FIG. 5 is a perspective view, with parts removed for clarity, of the repair system of FIG. 3;

FIG. 6 is a section view, with parts removed for clarity, of the repair system of FIG. 3;

FIG. 7 is an enlarged section view of a detail of the repair system of FIG. 3; and

FIG. 8 is a perspective view, with parts removed for clarity, of a further detail of the repair system of FIG. 3.

### DETAILED DESCRIPTION OF THE INVENTION

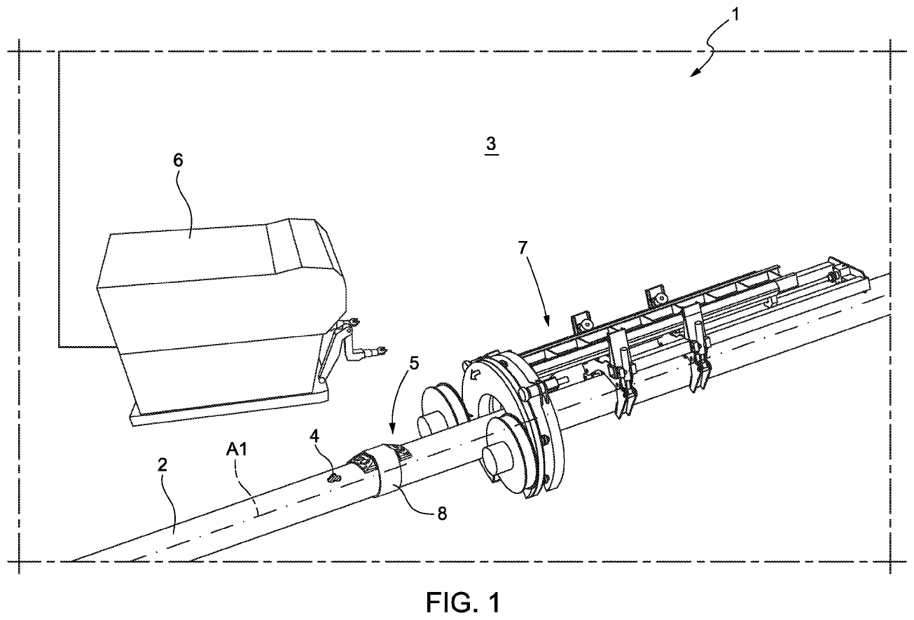

With reference to FIG. 1, the reference number 1 indicates, as a whole, an underwater intervention assembly for repairing localized defects of an underwater pipe 2 for fluid transport.

In the particular case described and illustrated here, the pipe 2 extends along a longitudinal axis Al in a body of water 3, is made at least partially of a metal material, and has localized defects 4.

In the context of the present invention, the term “localized defect” denotes a confined damaged portion of the metal material of the pipe 2 caused, for example, by corrosion. In particular, said localized defects 4 comprise cavities or cracks or dents or gashes in the walls of the pipe 2 that can run through the thickness of the walls of the pipe 2.

The intervention assembly 1 comprises a repair system 5 that can be installed on the pipe 2 to repair localized defects 4 of the pipe 2, and an unmanned underwater vehicle 6 to transport and install the repair system 5 on the pipe 2 to be repaired.

In accordance with an embodiment described and illustrated here, which does not limit the present invention, the underwater vehicle 6 is a remotely operated vehicle (ROV).

In accordance with a further embodiment, not shown in the accompanying figures, the underwater vehicle 6 is an autonomous underwater vehicle (AUV).

The intervention assembly 1 further comprises a machine 7 for applying a fastening assembly 8 around the repair system 5 and the pipe 2 in order to fix the repair system 5 on the pipe 2.

In the particular case described and illustrated in FIG. 1, which does not limit the present invention, the fastening assembly 8 comprises a composite material band to be wrapped around the repair system 5 and the pipe 2.

In particular, the machine 7 is configured to be clamped to the pipe 2 and is designed to be connected to the underwater vehicle 6, which is configured to transport and operate the machine 7 in the body of water 3 and to potentially assist in the execution of the operations of the machine 7.

According to a variant of the present invention, not shown in the accompanying figures, the underwater vehicle 6 is configured to transmit electrical and/or hydraulic power to the machine 7 and to control the machine 7.

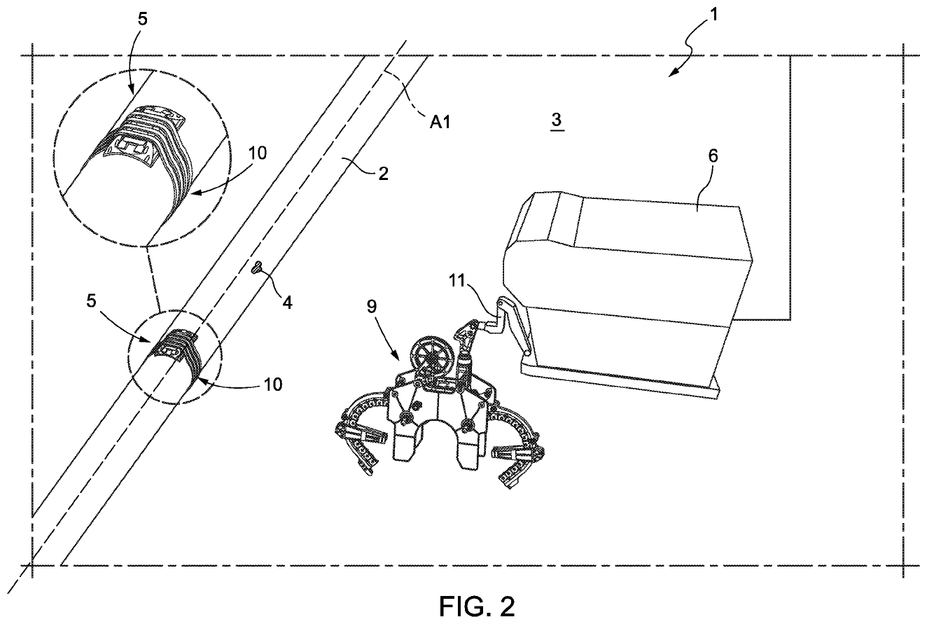

With reference to FIG. 2, a further embodiment of the present invention is shown, in which the intervention assembly 1 comprises a machine 9 configured to apply a fastening assembly 10 around the repair system 5 and the pipe 2 in order to fix the repair system 5 on the pipe 2.

In the particular case described and illustrated in FIG. 2, which does not limit the present invention, the fastening assembly 10 comprises at least one metal band, such as a strap, to be tied around the repair system 5 and the pipe 2.

In addition, the intervention assembly 1 comprises an articulated arm 11, which is connected to the underwater vehicle 6 and to the machine 9 in order to control the position of the machine 9 in the body of water 3.

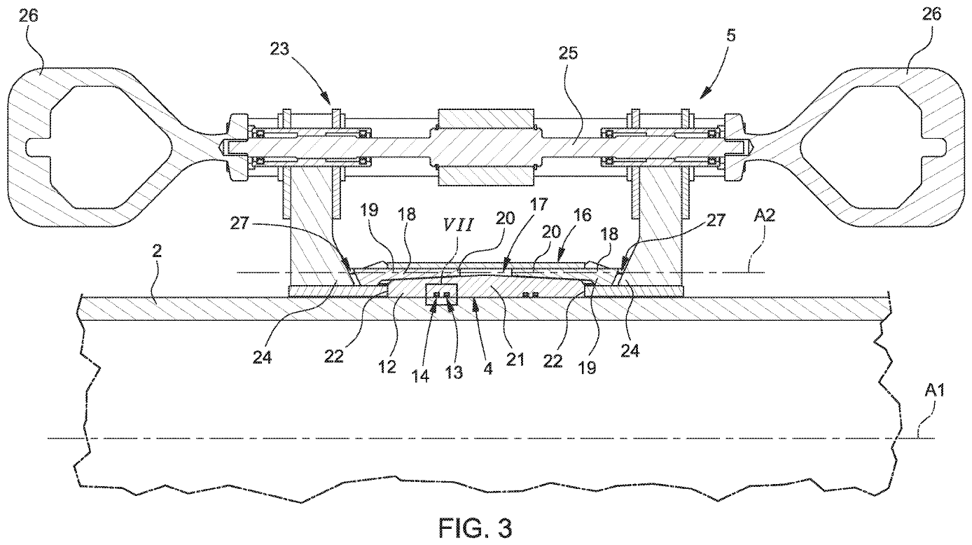

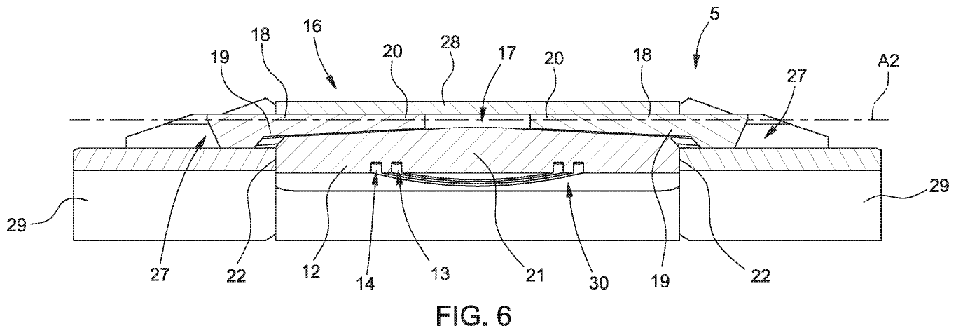

With reference to FIGS. 3 and 4, the repair system 5 extends along a longitudinal axis A2 and comprises a seal plate 12, which is configured to be arranged in contact with the outer surface of the pipe 2 above the defect 4 to be repaired and is provided with at least one seat 13, 14 for housing a seal gasket 15 (FIG. 7) around the defect 4 to be repaired; a compression frame 16, which is configured to be fixed to the pipe 2 and is arranged around the seal plate 12 so as to delimit together with the seal plate 12 a gap 17, which extends along the longitudinal axis A2 and has a variable size along the longitudinal axis A2; and at least one sliding element 18, which is configured to slide within the gap 17 along the longitudinal axis A2 and to wedge between the compression frame 16 and the seal plate 12 so as to push the seal plate 12 against the outer surface of the pipe 2.

In particular, the repair system 5 is configured to be arranged on the pipe 2 so that the longitudinal axis A2 of the repair system 5 is substantially parallel to the longitudinal axis Al of the pipe 2. In such a configuration, the sliding element 18 is configured to slide in a direction substantially parallel to the longitudinal axis Al.

According to a non-limiting embodiment of the present invention, the repair system 5 comprises a pair of wedge-shaped sliding elements 18 configured to slide oppositely along the longitudinal axis A2.

In practice, each sliding element 18 is configured to slide within the gap 17 along the longitudinal axis A2 between a release position (FIG. 3), in which the sliding element 18 exerts a minimal compression force on the seal plate 12, and a compression position (FIG. 4), in which the sliding element 18 is wedged under pressure within the gap 17. The distance between the two sliding elements 18 measured along the longitudinal axis A2 in the release position (FIG. 3) is greater than the distance between the two sliding elements 18 measured along the longitudinal axis A2 in the compression position (FIG. 4).

In particular, each sliding element 18 comprises a flattened body 19 provided with a wedge-shaped end portion 20, which is at least partially inserted within the gap 17 and is configured to wedge itself between the seal plate 12 and the compression frame 16.

The seal plate 12 comprises a central section 21 and a lateral end 22 aligned along the longitudinal axis A2. In particular, the seal plate 12 comprises two lateral ends 22 arranged on opposite sides along the longitudinal axis A2 with respect to the central section 21.

The thickness of the seal plate 12 is maximum at the central section 21 and minimum at each lateral end 22. In particular, said thickness is linearly decreasing along the longitudinal axis A2 from the central section 21 towards the lateral ends 22.

The seal plate 12 thereby delimits together with the compression frame 16 a gap 17 having a wedge-shaped longitudinal section corresponding to the wedge-shaped section of the end portion 20 of the sliding element 18.

According to one embodiment, the seal plate 12 and the compression frame 16 are made at least partially of a metal material. In particular, the seal plate 12 is made partly of stainless steel and partly of an elastomeric material. The compression frame 16 is made of stainless steel.

The repair system 5 also comprises an actuating device 23, which is selectively couplable/decouplable to/from each sliding element 18 and is configured to drive the sliding of each sliding element 18 along the longitudinal axis A2.

In particular, the actuating device 23 comprises two thrust pins 24, a sliding clamping mechanism 25 configured to selectively increase/decrease the distance between the thrust pins 24, and two control members 26 for driving the clamping mechanism 25.

In the particular case described and illustrated here, which does not limit the present invention, the clamping mechanism 25 is of a screw type and each control member 26 is configured to drive the screwing movement of the clamping mechanism 25.

It is understood that the clamping mechanism 25 can comprise actuators of different types, such as hydraulic or electromagnetic actuators, without departing from the scope of application of the present invention as a result.

Each sliding element 18 comprises a respective housing seat 27 configured to house the respective thrust pin 24 of the actuating device 23, which is configured to reduce the distance between the thrust pins 24 so as to bring about the sliding of each sliding element 18 within the gap 17 until each sliding element 18 is wedged between the seal plate 12 and the compression frame 16.

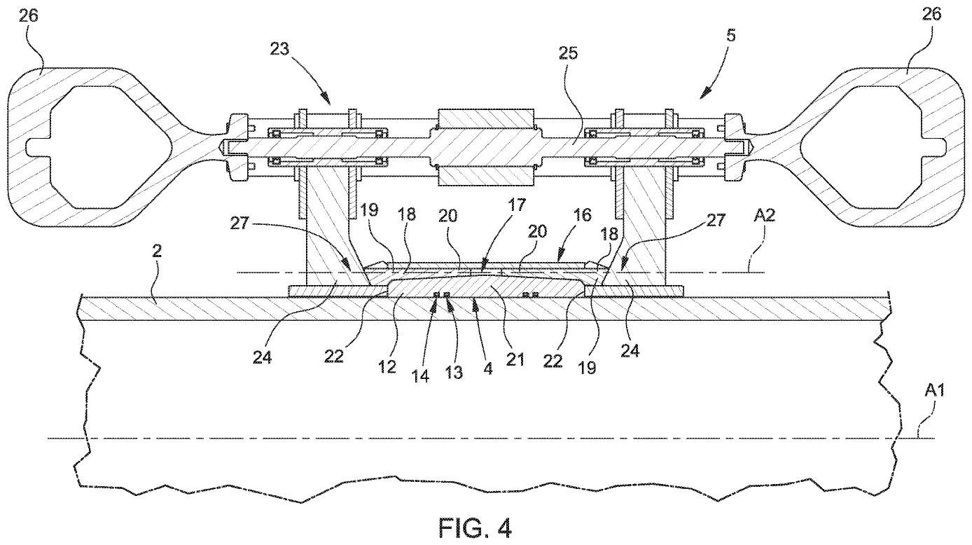

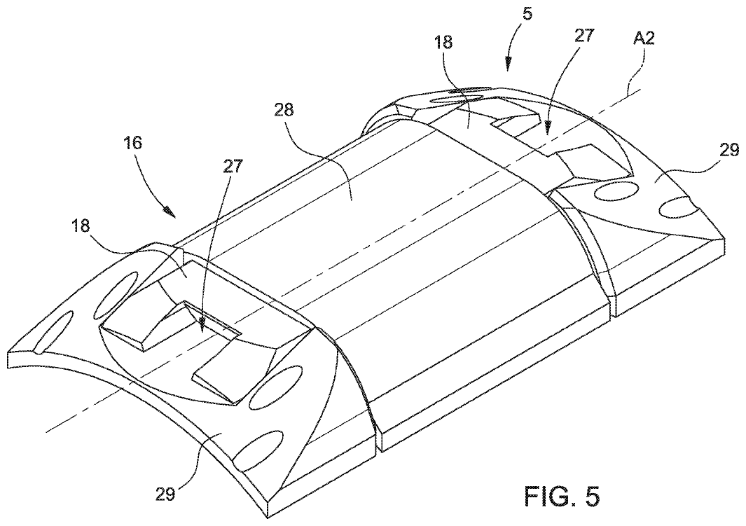

With reference to FIGS. 5 and 6, the compression frame 16 comprises a central portion 28 arranged around the seal plate 12 so as to delimit the gap 17 together with the seal plate 12, and a pair of lateral portions 29 fixed to the central portion 28 so as to enclose the seal plate 12 in a direction substantially parallel to the longitudinal axis A2. In other words, the central portion 28 and the lateral portions 29 determine the position of the seal plate 12 on the pipe 2.

With reference to FIG. 6, the seal plate 12 has a profile curved in a direction substantially perpendicular to the longitudinal axis A2 so as to follow the circumferential profile of the pipe 2 to be repaired.

Furthermore, the seal plate 12 comprises two seats 13, 14, each of which is configured to house a respective seal gasket 15 (FIG. 7).

In particular, the seat 14 is arranged concentrically around the seat 13. More specifically, each seat 13, 14 is substantially annular in shape and is formed in a face 30 of the seal plate 12 configured to be arranged in contact with the outer surface of the pipe 2.

With reference to FIG. 7, the repair system 5 comprises two seal gaskets 15, each of which is housed in its respective seat 13, 14. Each seal gasket 15 is made of a polymer material and has a C-shaped cross-section.

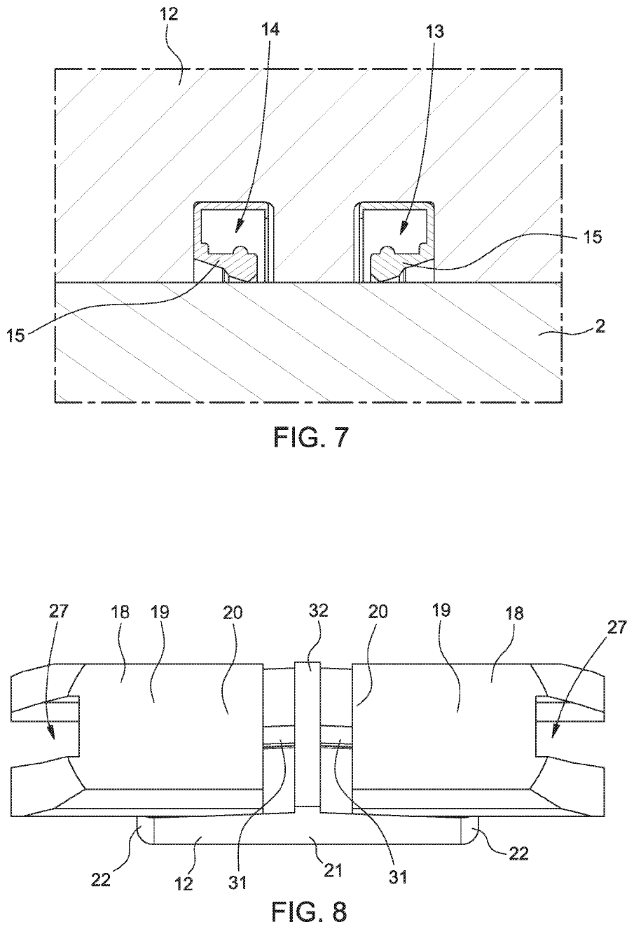

With reference to FIG. 8, the seal plate 12 comprises two sliding guides 31, each of which faces the central portion 28 of the compression frame 16, extends in a direction substantially parallel to the longitudinal axis A2 and is configured to guide the sliding of the respective sliding element 18 along the longitudinal axis A2. In particular, each sliding guide 31 is a rail extending in a direction substantially parallel to the longitudinal axis A2.

Furthermore, the seal plate 12 comprises a stop 32, which is arranged at the central section 21 and is configured to block the sliding of each sliding element 18 in the direction of the central section 21 of the seal plate 12.

In use and with reference to FIG. 1, the underwater vehicle 6 transports the repair system 5 in the body of water 3 to the pipe 2 and applies the repair system 5 to the pipe 2.

At this point, the machine 7 wraps the fastening assembly 8 in the form of a composite material band around the compression frame 16 and the pipe 2 so as to fix the repair system 5 on the pipe 2.

With reference to FIG. 3, the underwater vehicle 6 couples the actuating device 23 to each sliding element 18, so as to house each thrust pin 24 in the respective housing seat 27.

With reference to FIG. 4, the underwater vehicle 6 operates the clamping mechanism 25 via the two control members 26 by driving the sliding of the sliding elements 18 along the longitudinal axis A2 towards the central section 21 of the seal plate 12.

Once the two sliding elements 18 have been wedged between the central portion 28 of the compression frame 16 and the seal plate 12, the underwater vehicle 6 blocks the screwing motion of the clamping mechanism 25 and removes the actuating device 23 from the sliding elements 18. A retrograde movement of the sliding elements 18 is prevented by the friction exerted by the central portion 28 of the compression frame 16 and by the seal plate 12 on each sliding element 18. In other words, each sliding element 18 is held under pressure between the central portion 28 of the compression frame 16 and the seal plate 12.

The pressure exerted by each sliding element 18 against the seal plate 12 pushes the seal plate 12 onto the outer surface of the pipe 2. The seal gaskets 15 are compressed between the seal plate 12 and the outer surface of the pipe 2 and adhere to the seal plate 12 and to the outer surface of the pipe 2 so as to prevent the leakage of fluid from the pipe 2 and/or the entry of an external fluid into the pipe 2 through the defect 4.

Finally, it is evident that that variations can be made to the present invention with respect to the described embodiments without thereby departing from the scope of protection of the appended claims.

The invention claimed is:

1-18. (canceled)

19. A repair system configured to repair localized defects of a pipe configured to transport fluid, the repair system extending along a first longitudinal axis and comprising:
a seal plate configured to be arranged, in contact with an outer surface of the pipe, above a defect to be repaired;
a compression frame configured to be fixed to the pipe and arranged around the seal plate to delimit, together with the seal plate, a gap which extends along the first longitudinal axis and has a variable size along the first longitudinal axis; and
a sliding element configured to slide within the gap and along the first longitudinal axis to wedge between the compression frame and the seal plate to push the seal plate against the outer surface of the pipe.

20. The repair system of claim 19, wherein the pipe extends along a second longitudinal axis substantially parallel to the first longitudinal axis.

21. The repair system of claim 19, wherein the sliding element defines a wedge-shape.

22. The repair system of claim 21, further comprising a pair of sliding elements configured to slide oppositely along the first longitudinal axis.

23. The repair system of claim 19, wherein the seal plate defines a profile curved in a direction substantially perpendicular to the first longitudinal axis to follow a circumferential profile of the pipe.

24. The repair system of claim 19, wherein the seal plate comprises a central section and a lateral end aligned along the first longitudinal axis, a thickness of the seal plate being a maximum at the central section and a minimum at the lateral end.

25. The repair system of claim 24, wherein the thickness of the seal plate linearly decreases along the first longitudinal axis from the central section towards the lateral end.

26. The repair system of claim 19, wherein the seal plate comprises a sliding guide which faces the compression frame, extends in a direction substantially parallel to the first longitudinal axis and is configured to guide the sliding of the sliding element along the first longitudinal axis.

27. The repair system of claim 19, wherein the seal plate defines at least one seat configured to house a seal gasket around the defect to be repaired.

28. The repair system of claim 27, wherein the at least one seat defines a substantially annular shape and is formed in a face of the seal plate configured to be arranged in contact with the outer surface of the pipe.

29. The repair system of claim 28, wherein the seal plate defines a first seat and a second seat arranged concentrically around the first seat.

30. The repair system of claim 27, further comprising an annular seal gasket housed in the at least one seat and made of a polymeric material.

31. The repair system of claim 19, wherein the compression frame comprises:
a central portion arranged around the seal plate to delimit the gap together with the seal plate, and a pair of lateral portions fixed to the central portion to enclose the seal plate in a direction substantially parallel to the first longitudinal axis.

32. The repair system of claim 19, wherein the seal plate and the compression frame are each at least partially made of metal.

33. The repair system of claim 19, further comprising a fastening assembly configured to be arranged around the compression frame and the pipe to secure the compression frame to the pipe.

34. The repair system of claim 19, further comprising an actuating device selectively couplable to the sliding element and decouplable from the sliding element to drive the sliding of the sliding element along the first longitudinal axis.

35. An underwater intervention assembly for repairing localized defects of an underwater pipe configured to transport fluid, the intervention assembly comprising:
a repair system extending along a first longitudinal axis and comprising:
a seal plate configured to be arranged, in contact with an outer surface of the pipe, above a defect to be repaired, a compression frame configured to be fixed to the pipe and arranged around the seal plate to delimit, together with the seal plate, a gap which extends along the first longitudinal axis and has a variable size along the first longitudinal axis, and a sliding element configured to slide within the gap and along the first longitudinal axis to wedge between the compression frame and the seal plate to push the seal plate against the outer surface of the pipe; and
an unmanned underwater vehicle configured to transport and install the repair system on the pipe.

36. The intervention assembly of claim 35, further comprising a machine configured to apply a fastening assembly of the repair system around the compression frame of the repair system and the pipe.

37. A method of repairing localized defects of a pipe configured to transport fluid, the method comprising:
arranging a seal plate in contact with an outer surface of the pipe above a defect to be repaired;
arranging a compression frame around the seal plate to delimit, together with the seal plate, a gap which extends along a first longitudinal axis and has a variable size along the first longitudinal axis;
fixing the compression frame to the pipe by a fastening assembly; and
driving a a sliding element within the gap and along the first longitudinal axis to wedge the sliding element between the compression frame and the seal plate to push the seal plate against the outer surface of the pipe.
